(19) United States
(12) Patent Application Publication
(10) Pub. No.: US 2008/0124244 A1
(43) Pub. Date: May 29, 2008

(54) Testing device housing

(76) Inventors: Jennifer E. Sigel, Hoboken, NJ (US); Ellen Tawil, Morristown, NJ (US); Annette Young, Morris Plains, NJ (US)

Correspondence Address: Karen G. Horowitz;Warner Lambert Company LLC, 201 Tabor Road, Morris Plains, NJ, 07950, US

(21) Appl. No.: 11/598,843

(22) Filed: Nov. 13, 2006

Related U.S. Application Data
(63) Continuation-in-part of application No. 29/254,514, filed on Feb. 24, 2006, now Pat. No. D537168.
Application No. 29/254,514 is a continuation-in-part of application No. 29/254,513, filed on Feb. 24, 2006, now Pat. No. D537531.
Application No. 29/254,513 is a continuation-in-part of application No. 29/254,512, filed on Feb. 24, 2006, now Pat. No. D537167.
Application No. 29/254,512 is a continuation-in-part of application No. 29/254,613, filed on Feb. 24, 2006, now Pat. No. D537169.

(51) Int. Cl. G01N 21/01; B01L 11/00

(52) U.S. Cl. 422/58; 422/104

(57) ABSTRACT

A housing for a testing device formed to facilitate ergonomic and/or easy and stable gripping, particularly during specimen-collection. The housing is particularly suitable for use in a self-testing device. Various features may be provided in accordance with the principles of the present invention to achieve the ergonomic and/or easy and stable gripping. For instance, the gripping end of the housing is angled so that a user may readily hold the testing device to collect a specimen without soiling herself. Additionally, or alternatively, the housing may be proportioned to have lateral side surfaces with sufficient surface area to permit gripping of the housing not only on the top and bottom surfaces (as in typical testing devices), but also on only the lateral side surfaces. Additionally, or alternatively, the lateral side surfaces of at least the gripping section of the housing and/or the lateral side surfaces of the cap may be provided with surface texturing to enhance stable gripping.

### CROSS-REFERENCE TO RELATED APPLICATIONS

The present application is a continuation-in-part and claims the benefit under 35 U.S.C. § 120 of the earlier filing dates of U.S. design patent application Ser. No. 29/254,514, filed Feb. 24, 2006; Ser. No. 29/254,513, filed Feb. 24, 2006; Ser. No. 29/254,512, filed Feb. 24, 2006; and Ser. No. 29/254,613, filed Feb. 24, 2006; which applications are hereby incorporated by reference herein in their entireties.

### FIELD OF THE INVENTION

The present invention relates to a housing for a testing device. More particularly, the present invention relates to an ergonomic and/or user-friendly portable, hand-held testing device housing designed to facilitate use of the testing device.

### BACKGROUND OF THE INVENTION

Various portable testing devices are known in the art for permitting a user to perform, conveniently, qualitative and/or quantitative tests for a medical condition; and/or exposure to therapeutic drugs, intoxicants, hazardous chemicals, and the like; and/or presence or absence of other chemical and/or biological constituents in a biological sample. Such testing devices are designed to provide a result directly to a user without requiring further processing, such as at a remote location. Accordingly, such testing devices may be sold as self-testing devices because a user need not have special expertise or training to use such device. In fact, such self-testing devices preferably are hand-held and may even be disposable.

A popular form for a portable testing device includes a housing that holds means for collecting a biological sample and conveying the sample for testing at a reaction zone within the housing. A physically detectable change may occur at the reaction zone (which thus also functions as a test result zone) or at a generally downstream separate test result zone to indicate the test results. A control zone may be provided to indicate that the biological sample was properly collected and conveyed for testing. The biological sample may be a fluid containing an analyte that migrates, through a porous material, from the collection area of the testing device to a reaction zone that is configured to permit one or more specific binding reactions. For instance, the reaction zone may contain a labeled reagent that reacts or binds with the analyte to form an observable complex of a labeled reagent and analyte indicating the presence of the analyte in the liquid biological sample, and thus indicating a medical condition being tested. Alternatively, the results of the reaction may cause a test result zone to display a visual indication (e.g., color change, symbols, or words) of the test result, such as a representation of the presence and/or quantity/level/concentration of an analyte in the biological sample. The test result is displayed for the user, such as through a window in the region of the housing in which the reaction zone is contained.

One manner of collecting the biological sample is through the use of a fluid collecting and conveying element (often called an “absorbent tip”), which may be in the form of an absorbent pad or wick, such as a dry porous carrier or bibulous liquid biological sample-receiving member, capable of absorbing and conveying fluid rapidly. The biological sample is applied to a sample collection region and then transported along a liquid transport path into an evaluation region or reaction zone that may be provided on a separate bibulous pad. Alternatively, the fluid collecting and conveying element may be a single longitudinally extending bibulous wicking element that both receives the sample and also conveys the sample to a downstream reaction zone thereon, and thus permits differentiation between a sample application region and an evaluation region. The test result zone may be a third element, or part of the element incorporating the reaction zone. At least the element at which the biological sample is evaluated or tested may be referenced as a “test strip” because, for a variety of reasons, such element (collectively, if several components are used) generally relies heavily on longitudinal transport and is generally flat (to regulate the quantity of and speed at which fluid is transported to assure efficient and effective functioning) and elongated.

The test strip of typical portable testing devices is held in a housing typically made of a light-weight water-impermeable material, such as plastic. The sample-collecting element (“absorbent tip”), which collects the biological specimen and conveys it for analysis, extends outside a “testing” end of the housing to receive the biological sample. For instance, the absorbent tip may be introduced into a stream of liquid for collection of the sample. A cap may be used to cover the sample-collecting element after collection of a fluid sample (such as to prevent contamination, or moisture loss from the sample-collecting element), and the testing device may then be placed aside by the user for the necessary time for the sample to permeate and migrate along the test strip to a reaction zone, and for the reaction to occur. The reaction zone and test result zone are enclosed within the housing downstream of the testing end of the housing. A window is formed in the housing, extending over the test result zone (and control zone, if one is present) so the user can observe and detect the test results (and accuracy of the testing procedure if a control zone is provided). The reaction zone may utilize digital or analog technology, and therefore the window may be a simple window permitting viewing of the actual test result zone, or a liquid crystal display displaying the results of the test in a user-friendly format.

It is generally desirable to have a testing device housing that is user-friendly, and easy to use and to manipulate, particularly during collection of the biological sample. However, to simplify design and manufacturing, the shape and dimensions of the testing device housing often are simply dictated by the elements to be contained therein, without much attention to configurations that facilitate use and handling of the device. Thus, a typical testing device cap may be flat and wide to cover a typical absorbent tip which has as wide a collection area as possible (to facilitate collection of a sample) and a correspondingly relatively small thickness (so as not to use more material than necessary and to reduce the risk of flooding of the test strip resulting from absorption of too much specimen). Such dimensions when applied to an absorbent tip assure efficient and accurate sample collection without affecting testing by flooding, yet are not necessarily user-friendly when applied to a cap for covering such absorbent tip.

A testing device housing may be generally flat as well, with proportions driven by a typical test strip that is essentially flat, having a thickness (the distance between the top and bottom surfaces extending along the width of the strip) several times smaller than its width (extending in a direction substantially perpendicular to the elongated length). For instance, certain pregnancy testing devices use a sandwich assay with a test strip in a flat, thin strip format. Reagents located within the housing pick up (typically) HCG from the urine sample collected by the absorbent tip. Because the sequence of capturing the sample is important (the urine sample must reach certain reaction compounds before reaching other reaction compounds), and the amount of urine being tested is also important (as too much urine, known as “flooding,” can invalidate the test), the configuration of the wick and test strip is very important to the functionality. The test strip thus may have a relatively high width to thickness ratio to regulate fluid flow and to assure the appropriate quantities of liquid are conveyed therethrough for proper interactions with the reagents therein. A housing designed based on the test strip to be housed therein would have significantly more surface area for gripping the device on the top and bottom surfaces (extending along the width of the testing device) than on the lateral side surfaces (extending between the top and bottom surfaces along the thickness of the testing device). The user therefore is generally limited to gripping the device with her fingers in only one orientation—on the top and bottom surfaces. If manipulation of the testing device is desired, then the user must rotate or twist her wrist and/or arm rather than simply reposition her grip on the testing device. Such a flat housing that may be awkward to hold in a stable position during specimen collection. It would be desirable to enhance the housing configuration to facilitate gripping as well as manipulation of the housing, particularly during specimen collection.

It is further desirable to form the testing device so that it is easy to use without soiling the user's hand or fingers during specimen collection. For instance, a common form of a portable testing device is a pregnancy tester that permits simple, quick testing of whether or not the user is pregnant by detecting human chorionic gonadotropin (HCG) excreted in the woman's urine. The sample-collecting element of a typical such pregnancy testing device is to be placed in a stream of urine to collect a sufficient amount of biological sample for testing. The awkwardness of such sample collection increases the desirability of a testing device housing shaped to minimize the chances of the user soiling her hands or fingers during sample collection and to maximize the ergonomics of sample collection.

As noted above, the sample collection region of the sample-collecting element or absorbent tip typically extends outside a testing end of the testing device housing. It may be desirable to provide a cap to cover the sample collection region to prevent contamination or accidental unintended absorption of a fluid that is not the biological specimen to be tested. It would be desirable to provide a cap that is easy to remove and to manipulate, thus further increasing the ease of use of the testing device.

Accordingly, there remains a need in the industry for improved testing device housings that facilitate handling and use thereof.

### SUMMARY OF THE INVENTION

In accordance with the principles of the present invention, a housing for a portable testing device is formed to facilitate use of the testing device. Various features of the housing individually contribute to facilitating use of the testing device, and such features may, but need not, be provided in the same housing.

Instead of substantially following the essentially elongated flat shape of the test strip therein, a testing device housing formed in accordance with the principles of the present invention may be formed to have an increased thickness such that the ratio of the thickness to the width is significantly greater than the thickness to width ratio of the testing strip housed therein. The thickness of the housing preferably is selected to provide a sufficient gripping area permitting stable gripping of the lateral sides (instead of the top and/or bottom surfaces) of the testing device housing extending along the thickness of the testing device housing. Such increased thickness permits stable gripping of the testing device housing in any orientation whereas prior art testing devices typically have a much smaller thickness (because the test strip generally has a thickness significantly smaller than its width) and thus permit stable gripping only along the top and bottom surfaces of the testing device housing.

Because the increased thickness of the testing device housing facilitates gripping of the lateral side surfaces of the testing device housing, in accordance with a further aspect of the present invention, surface texturing (e.g., ribs, grooves, roughening, raised or textured surface patterns, etc.) may be provided not only on the top and/or bottom surfaces but also on the lateral side surfaces of the testing device housing extending along the thickness of the housing. Such surface texturing further enhancing stable gripping of the testing device housing.

In accordance with another aspect of the present invention, a testing device housing may be formed to facilitate collection of a biological sample by a user performing a self-test while also reducing the likelihood of direct contact with the sample biological fluid during collection. In particular, the sample-collecting end of a testing device for self-testing often is provided at an extreme end of the testing device housing to reduce the likelihood of direct contact between the sample biological fluid to be collected and the hands and/or fingers of the user as the specimen is collected. For instance, the sample-collecting end of a pregnancy tester is generally provided at an extreme end of an elongated testing device housing long enough to permit gripping of the testing device housing far enough from the stream of urine during sample collection. In accordance with one aspect of the present invention, a testing device housing may be elongated to house an elongated test strip therein, and may further include an ergonomic gripping section at a proximal-most end opposite the distal specimen-collecting end. The ergonomic gripping section is distinguished by being angled with respect to the major longitudinal axis of the housing in a direction upward from the top surface of the testing device (generally defined as the surface in which a window for viewing test results is provided). In other words, the major plane of the ergonomic gripping section (i.e., the plane in which the top and bottom surfaces of the gripping section lie) is angled upwardly from the major plane of the testing device housing (i.e., the plane in which the top and bottom surfaces of the testing device housing lie) during use. Thus, if the sample collecting region is held in a urine stream, the gripping section is angled upward towards the user's hand and is easier to hold during sample collection. A finger depression may be provided on the top and/or bottom surfaces of the ergonomic gripping section to further facilitate gripping of the gripping section.

These and other features and advantages of the present invention will be readily apparent from the following detailed description of the invention, the scope of the invention being set out in the appended claims.

### BRIEF DESCRIPTION OF THE DRAWINGS

The detailed description will be better understood in conjunction with the accompanying drawings, wherein like reference characters represent like elements, and in which:

FIG. 1 is a perspective view of a testing device housing formed in accordance with the principles of the present invention;

FIG. 2 is a side elevational view of a testing device housing formed in accordance with the principles of the present invention with the cap removed to show the testing device ready for specimen collection;

FIG. 3 is a top plan view of a testing device housing as in FIG. 1;

FIG. 4 is back end view of a testing device housing as in FIG. 1;

FIG. 5 is a bottom plan view of a testing device housing as in FIG. 1;

FIG. 6 is perspective view of a testing device housing similar to that in FIG. 1, but with the cap removed; and

FIG. 7 is a top plan view of a testing device housing similar to that of FIG. 1, but showing a cap having sides substantially coextensive with the sides of the testing device main housing.

### DETAILED DESCRIPTION OF THE INVENTION

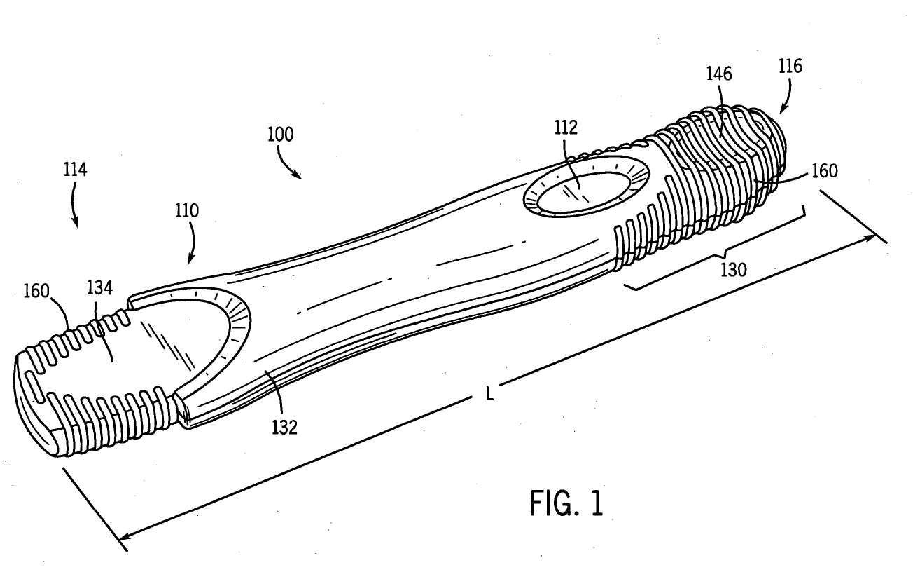

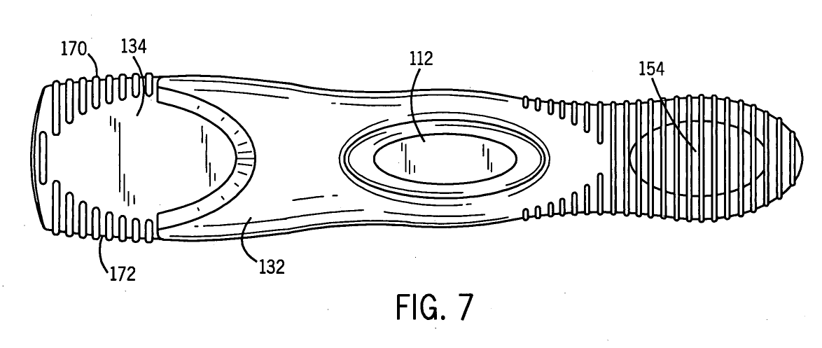

An exemplary portable testing device 100 formed in accordance with the principles of the present invention is illustrated in FIGS. 1-7. Testing device 100 has a generally elongated housing 110 for components for receiving and testing a biological sample or specimen (the terms specimen and sample are used interchangeably herein). Any of the various testing methods and devices known in the art may be used to determine the medical condition being tested. Such technology does not form a part of the claimed invention and thus is not described in detail. A window 112 may be formed in housing 110 to display results of the test to be performed by testing device 100. The position of window 112 along the length L of housing 110 (extending along the longitudinal axis of housing 110) may be determined based on a variety of factors, such as the required distance of the result region of the testing components within housing 110 from specimen-collecting end 114. In the exemplary housing of FIGS. 1-6, window 112 is adjacent to gripping end 116 of housing 110. However, it will be appreciated that window 112 may be provided in other locations as well as in other shapes, such as illustrated in FIG. 7.

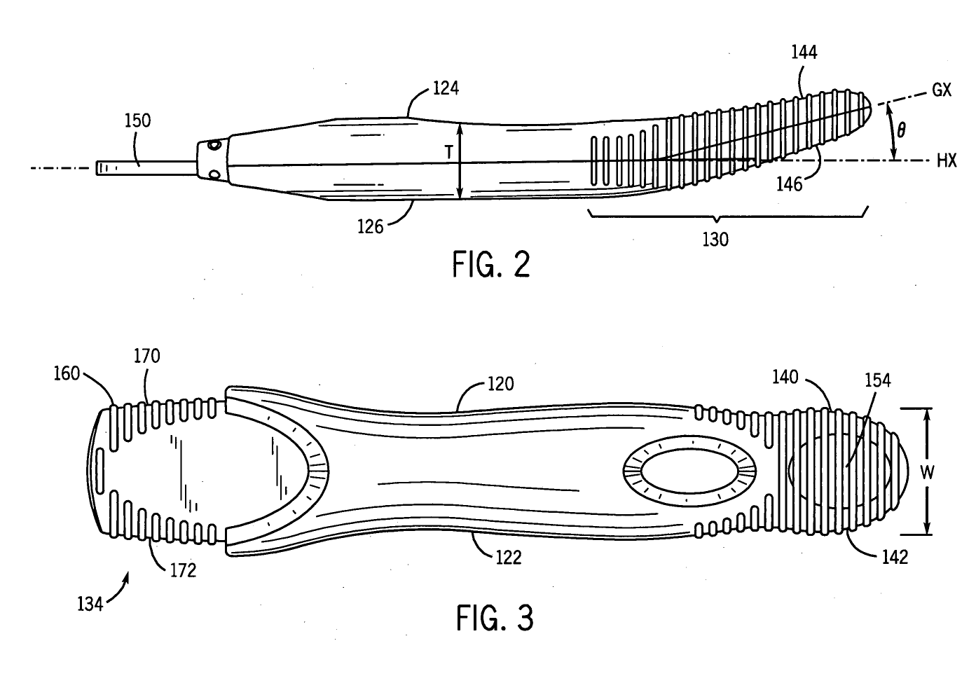

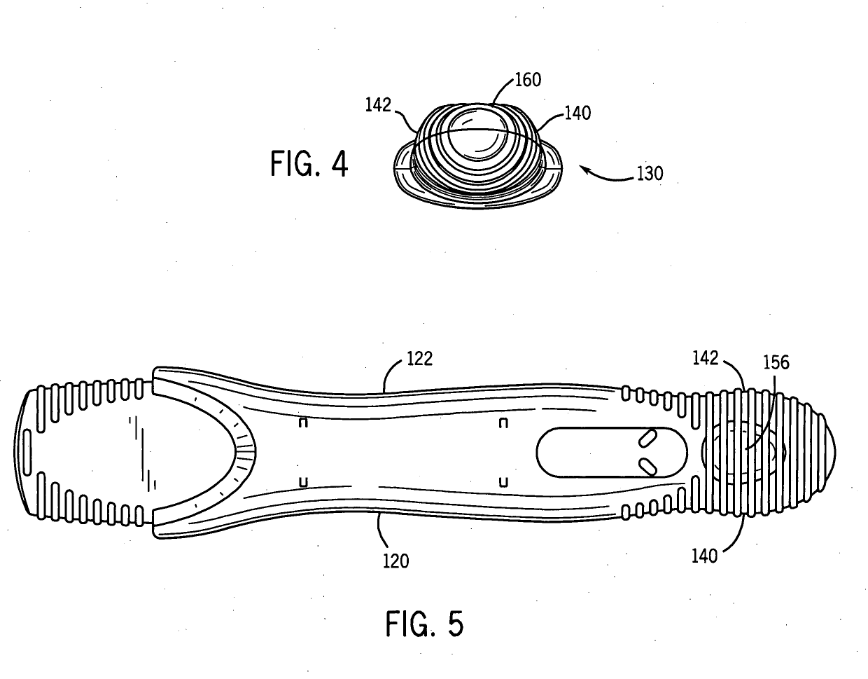

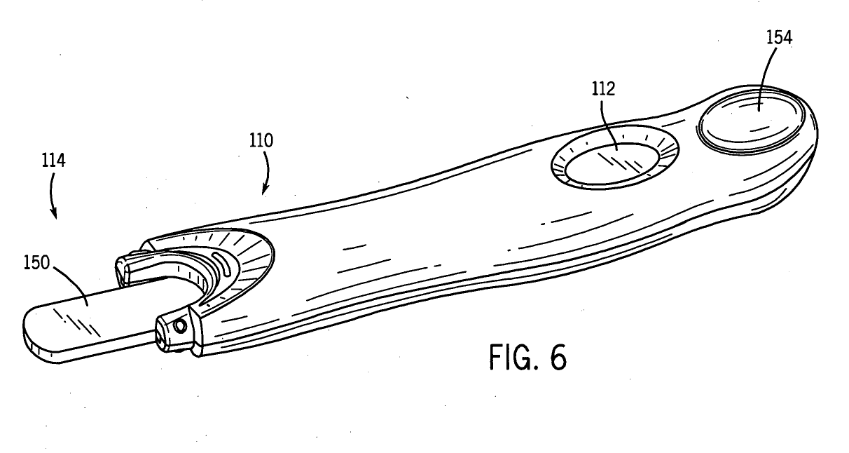

In accordance with the principles of the present invention, the average thickness T of housing 110 (indicated in FIG. 2) is significantly greater relative to average width W (indicated in FIG. 3) than in prior art portable testing device housings, particularly analog testing device housings. Thus, the ratio of average thickness T to average width W preferably is significantly greater than the ratio of the thickness to the width of a typical test strip housed within housing 110. Such increased housing thickness preferably is specifically provided along gripping section 130 (at proximal gripping end 116 of housing 110), as may be appreciated with reference to FIG. 4, and may also be maintained along a majority, if not all, of the length of housing 110. If desired, cap 134 (which may broadly be considered a component of housing 110) may have an increased thickness as well. Average thickness T of housing 110 preferably is selected to provide a sufficient gripping area permitting stable gripping of lateral side surfaces 120, 122 of housing 110, and, more particularly, lateral side surfaces 140, 142 of gripping section 130. For instance, average thickness T may be no less than approximately 1 cm. Such dimensions permit a user the option of gripping not only top and bottom surfaces 124, 126 of housing 110 and, more particularly, top and bottom surfaces 144, 146 of gripping section 130 (the only surfaces of prior art testing device housings permitting stable gripping), but also lateral side surfaces 120, 122, 140, 142 extending along average thickness T of housing 110. Stable gripping of housing 110 thus may be maintained during collection of a biological sample regardless of the manner in which housing 110 is gripped so that a sample-collecting element 150 (e.g., an absorbent bibulous tip that receives, collects, and absorbs a specimen and conveys the specimen to the testing components within housing 110, and thus which may be considered an exposed specimen-collecting element extending from within housing 110) extending from specimen-collecting end 114 (such as illustrated in FIG. 6) is maintained in a desired optimal orientation for receiving/capturing the specimen. If desired, indents 154, 156 may be provided on top and bottom surfaces 144, 146 of gripping section 130, as illustrated in FIGS. 3 and 5, further facilitating gripping. Moreover, as illustrated in FIG. 4, lateral side surfaces 120, 122, 140, 142 may be curved such that housing 110 has an overall smoothly curved surface with gradual rounded transitions from lateral side surfaces 120, 122, 140, 142 to top and bottom surfaces 124, 126, 144, 146 without discontinuities caused by edges or corners at intersections between top and bottom surfaces and lateral side surfaces of at least gripping section 130, or of the entire housing 110, as in prior art testing device housings with generally rectangular cross-sections.

In accordance with a further aspect of the present invention, the increased surface area of lateral side surfaces 120, 122, 140, 142 of housing 110 permits provision of surface texturing 160 (e.g., ribs, grooves, roughening, raised or indented or textured surface patterns, etc.) on not only areas of top and/or bottom surfaces 124, 126, 144, 146 but also on lateral side surfaces 120, 122, 140, 142 of housing 110, extending along the thickness T of housing 110, as illustrated, for example, in FIG. 1. Because prior art testing device housings had proportionately small thicknesses, provision of surface texturing on side surfaces had not previously been contemplated for prior art housings. Surface texturing 160 may extend completely around the circumference of at least selected regions of housing 110, such as completely around gripping section 130, such as illustrated in FIG. 4. Such surface texturing further enhances stable gripping of housing 110 at any location around the housing 110 and in any orientation.

In addition, surface texturing 160 may be provided along the lateral side surfaces 170, 172 of cap 134 to facilitate removal of cap 134 to expose sample-collecting element 150. Such side surface texturing permits easier removal of a cap than in prior art testing devices that have surface texturing only on top and/or bottom surfaces. It will be appreciated that the shape of cap 134 may be modified as desired to further facilitate grasping, manipulation, and removal. For example, as illustrated in FIG. 7, the width of cap 134 may be substantially coextensive with the width of main housing 132 at specimen-collecting end 114. Moreover, optional rounding of lateral side surfaces 170, 172 may also facilitate grasping, manipulation, and removal of cap 134.

In accordance with another aspect of the present invention, the shape of housing 110 of testing device 100 may facilitate use not only by its easy-to-grasp dimensions, but also by its contour. In particular, housing 110 may be contoured to facilitate collection of a biological fluid sample by a user performing a self-test while also reducing the likelihood of direct contact with the sample biological fluid during collection. The sample-collecting end 114 of a testing device 100 for self-testing is generally provided at an extreme end of the testing device housing 110 to reduce the likelihood of direct contact between the sample biological fluid to be collected and the hands and/or fingers of the user as the specimen is collected. The gripping section 130 of housing 110 is formed at the other, proximal grasping end 116 of housing 110 sufficiently far from sample-collecting end 114 to avoid contact with the biological fluid specimen. The desire for gripping section 130 to be a sufficient distance from sample-collecting end 114 must be balanced with the gripping section 130 not being so far as to be awkward to grasp during collection of a fluid specimen on sample-collecting element 150. As illustrated in FIG. 2, in accordance with the principles of the present invention, gripping section 130 may be angled upwardly with respect to the remainder of housing 110. More particularly, grip axis GX of gripping section 130, extending along the major plane of gripping section 130 (i.e., the plane along which top and bottom surfaces 144, 146 of gripping section 130 extend), may be at an angle θ upward from major longitudinal axis HX of housing 110 lying in the major plane of the majority of housing 110 (i.e., in the plane along which top and bottom surfaces 124, 126 of housing 110 primarily extend). Thus, if sample-collecting element 150 is held in a urine stream, gripping section 130 is angled upward towards the user's hand and is easier to hold during sample collection, despite an overall length of housing 110 (the distance between distal sample-collecting end 114 and proximal grasping end 116) that maximizes the distance of gripping section 130 from sample-collecting element 150. The presence of optional finger depressions 154, 156 may further facilitate gripping of gripping section 130.

One exemplary use for testing device 100 is as a pregnancy tester. Another exemplary use is an ovulation testing device. The improved dimensions and/or contour of the present invention may be utilized to form a housing that facilitates use and allows easy gripping and manipulation of the testing device during use, when the user may be a bit nervous or tired (such as if a first urine sample of the day is used for testing). However, it will be appreciated that the testing device housing modifications taught by the present invention may be applied to other types of testing devices with similar benefits resulting from such modifications.

While a testing device housing formed in accordance with the principles of the present invention is particularly shown and described herein with reference to the particular embodiment illustrated in the drawings, it is to be understood that the present invention may be used with many additions, substitutions, or modifications of form, structure, arrangement, proportions, materials, and components and otherwise, used in the practice of the invention, which are particularly adapted to specific environments and operative requirements without departing from the spirit and scope of the present invention as defined in the accompanying claims. In particular, it will be clear to those skilled in the art that the present invention may be embodied in other specific forms, structures, arrangements, proportions, and with other elements, materials, and components, without departing from the spirit or essential characteristics thereof. The presently disclosed embodiments are therefore to be considered in all respects as illustrative and not restrictive, the scope of the invention being indicated by the appended claims, and not limited to the foregoing description.

What is claimed is:

1. A testing device comprising a housing configured to house an elongated test strip, said housing having a distal specimen-collecting end, a proximal gripping end, and a gripping section along said proximal gripping end, wherein:
said housing has top and bottom surfaces extending along a main housing major plane;
said gripping section has top and bottom surfaces extending along a gripping section major plane; and
said gripping section major plane extends upwardly at an angle with respect to said main housing major plane such that said gripping section and lies in a plane above said distal specimen-collecting end of said housing.

2. A testing device as in claim 1, wherein:
said housing houses an elongated flat test strip comprising a sample-collecting element extending outside said housing from said distal specimen-collecting end of said housing, and a reaction zone within said housing;
said sample-collecting element is configured to collect a biological specimen from a user of said testing device and to convey the biological specimen to said reaction zone; and
said reaction zone performs a test on the biological specimen such that said testing device is a self-testing device providing a user directly with a test result.

3. A testing device as in claim 2, wherein:
said test strip includes a test result zone indicating the result of the test performed at said reaction zone; and
a window is formed in said housing to view said test result zone.

4. A testing device as in claim 1, wherein indents are formed in said top and bottom surfaces of said gripping section.

5. A testing device as in claim 1, wherein said testing device is a pregnancy tester.

6. A testing device comprising a housing configured to house an elongated flat test strip, wherein:
said housing has top and bottom surfaces, and lateral side surfaces extending between said top and bottom surfaces;
said lateral side surfaces have a width, in a direction extending from said top surface to said bottom surface, sufficiently large for a user to grip said housing stably by holding only said lateral side surfaces.

7. A testing device as in claim 6, wherein:
said housing is elongated and has a length greater than a thickness;
said lateral side surfaces extend along the thickness of said housing and have a length extending along the length of said housing and a width extending along the thickness of said housing; and
said lateral side surfaces have a width of at least about 1 cm.

8. A testing device as in claim 6, wherein said lateral side surfaces are convex.

9. A testing device as in claim 6, wherein:
said housing and the test strip therein have a length comprising the greatest dimension thereof, a width extending substantially perpendicular to said length between said housing lateral side surfaces, and a thickness extending substantially perpendicular to said length and said width along said housing lateral side surfaces; and
the width to thickness ratio of the elongated test strip is significantly greater than the average width to thickness ratio of said housing.

10. A testing device as in claim 6, wherein:
said testing device is a pregnancy tester; and
said lateral side surfaces are configured to facilitate stable gripping of said testing device housing during collection of a urine specimen by gripping only said lateral side surfaces.

11. A housing for a pregnancy testing device, wherein:
said housing is configured to house an elongated test strip and has: a distal specimen-collecting end from which a specimen-collecting element extends, a proximal gripping end, a gripping section along said proximal gripping end, top and bottom surfaces, and lateral side surfaces extending between said top and bottom surfaces; and
surface texturing is provided along said top and bottom surfaces as well as along said lateral side surfaces of at least said gripping section.

12. A housing as in claim 11, wherein said surface texturing extends continuously around said housing over said top and bottom surfaces as well as over said lateral side surfaces.

13. A housing as in claim 12, wherein said surface texturing is selected from: ribs, grooves, roughening, raised surface patterns, or indented surface patterns.

14. A housing as in claim 11, further comprising a removable cap selectively covering the specimen-collecting element extending from said specimen-collecting end of said housing.

15. A housing as in claim 14, wherein
said cap has top and bottom surfaces and lateral side surfaces extending between said top and bottom surfaces; and
surface texturing is provided along said top and bottom surfaces as well as along said lateral side surfaces of said cap.

16. A housing as in claim 14, wherein surface texturing is provided on said cap to facilitate removal of said cap from a position covering the specimen-collecting element.
